(19) United States
(12) Patent Application Publication
(10) Pub. No.: US 2007/0101885 A1
(43) Pub. Date: May 10, 2007

(54) System for monitoring contamination of a substrate surface using a contact cleaning roller

(75) Inventors: Frank C. Corrado, Rochester, NY (US); Gary R. Larsen, Webster, NY (US); Ronald W. Sweet, Conesus, NY (US); James W. Fischer, Rochester, NY (US)

Correspondence Address: Robert C. Brown, 1207 Sandhurst Drive, Tallahassee, FL, 32312, US

(73) Assignee: Seratek, LLC

(21) Appl. No.: 11/595,519

(22) Filed: Nov. 10, 2006

Related U.S. Application Data
(60) Provisional application No. 60/735,540, filed on Nov. 10, 2005.

(51) Int. Cl. B41F 35/00

(52) U.S. Cl. 101/425

(57) ABSTRACT

A CCR system 100,200 for removing and analyzing particles from a surface 104 of a substrate 102. A CCR 113 is selectively contactable with the substrate surface. The CCR rolls along the surface, which typically is drawn past the CCR as a continuous moving web on a roller 108, the CCR being rotatably mounted on an axle of the system. In a first embodiment 100, the CCR may be removed for off-line analysis of contamination. In a second embodiment 200, the CCR may remain in operation for real-time analysis of removed contamination. A video camera 122,222 scans the CCR surface and transmits images or data for visual and/or computer analysis of the contamination, which analysis may include, but is not limited to, computerized shape analysis of particles, areal distribution of particles, and composition of particles.

### RELATIONSHIP TO OTHER APPLICATIONS AND PATENTS

The present application draws priority from a pending U.S. Provisional patent application, Ser. No. 60/735,540, filed Nov. 10, 2005.

### TECHNICAL FIELD

The present invention relates to method and apparatus for assessing contamination type and severity on a substrate; more particularly, to method and apparatus for permitting video analysis of substrate particulate contamination removed from a substrate surface by a contact cleaning roller.

### BACKGROUND OF THE INVENTION

In many sheet-based and web-based processes today, the sheet or web must be cleaned of particulate contaminants before a coating can be applied. It is known to clean sheets and rollers by rolling impingment of a high-tack roller surface; see, for example, U.S. Pat. Nos. 5,611,281 and 6,196,128. A polymer-covered roller having a particle-attractive surface is known generally in the art as a “contact cleaning” roller (CCR). A CCR functions by having an attraction for particles greater than the attraction of the surface to be cleaned by the roller.

In some sheet-based and web-based processes, it is of especial interest to know the size, shape, type, and/or frequency of particles contaminating a substrate surface. Conducting such analysis in real time on the substrate itself can be difficult or impossible, as the substrate is typically moving at high speed and the contaminants may be widely separated in both length and width of the substrate.

What is needed in the art is an improved method and apparatus for monitoring substrate contamination.

It is a principal object of the present invention to monitor substrate contamination by collecting, concentrating, and video analyzing particles from a substrate surface.

### SUMMARY OF THE INVENTION

Briefly described, a CCR system for removing and analyzing particulate contaminants from a substrate surface comprises at least one CCR selectively contactable with the substrate surface. The CCR rolls along the surface which typically is drawn past the CCR as a continuous moving web, the CCR being rotatably mounted on an axle of the system. The CCR may remain in operation for real-time analysis of removed contamination, or the CCR may be removed for off-line analysis of the partculate contamination. A video camera scans the CCR surface and transmits images or data for visual and/or computer analysis of the contamination, which analysis may include, but is not limited to, computerized shape analysis of particles, areal distribution of particles, and composition of particles. The computer may be programmed in known fashion for conducting such analyses.

### BRIEF DESCRIPTION OF THE DRAWINGS

The present invention will now be described, by way of example, with reference to the accompanying drawings, in which:

FIG. 1 is a plan view of a first embodiment of a substrate contamination monitoring system employing a contact cleaning roller, in accordance with the invention;

FIG. 2 is an end view of the first embodiment shown in FIG. 1; and

FIG. 3 is an end view of a second embodiment of a substrate contamination monitoring system employing a contact cleaning roller, in accordance with the invention.

### DESCRIPTION OF THE PREFERRED EMBODIMENTS

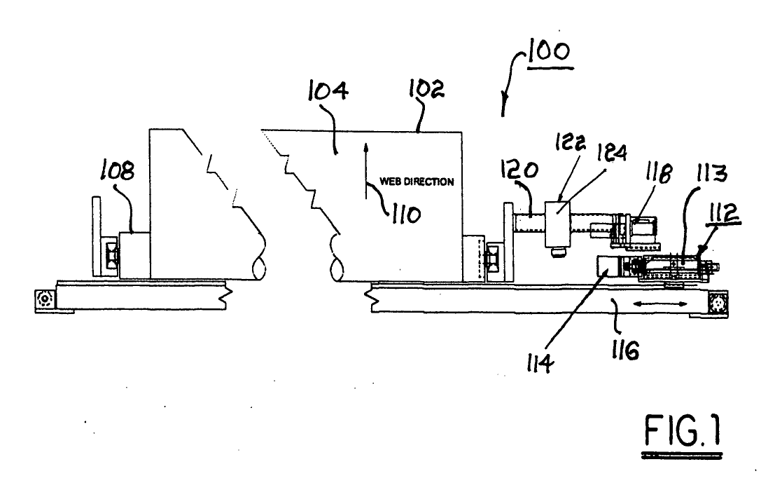

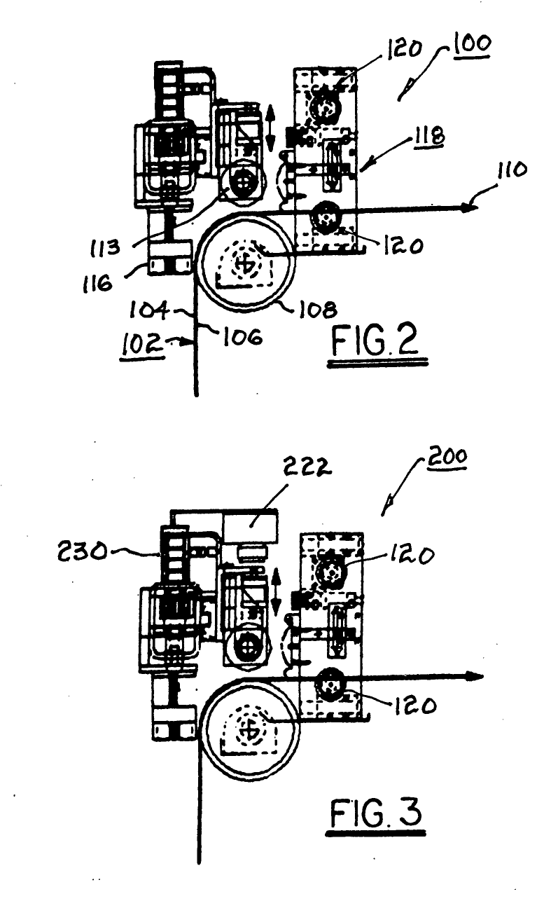

Referring to FIGS. 1 and 2, in a first embodiment 100 of a substrate contamination monitoring system in accordance with the invention, a planar flexible substrate 102 having particulate contamination on a first surface 104 thereof is conveyed on a second surface thereof 106 around a roller 108 in a first conveyance direction 110 in known fashion. A prior art traversing CCR assembly 112 comprising a contact cleaning roller 113, which assembly preferably includes a speed-matching motor 114 for bringing the rotational speed of CCR 113 to substrate conveyance speed prior to engagement therewith in known fashion, is mounted on a first stationary rail 116 for traversing assembly 112 transversely to any of a plurality of first positions adjacent surface 104 for removing particles therefrom in known fashion. A prior art CCR wash unit 118 is mounted on a second stationary rail 120 adjacent an edge of substrate 102 for cleaning and regenerating CCR 113 off-line in known fashion. A camera means 122 is also mounted on second stationary rail 120 adjacent an edge of substrate 102 in position to photograph the surface of CCR 113 after CCR 113 has been retracted from substrate-cleaning mode along first stationary rail 116 to one or more second positions. Means may be provided for rotating and axially displacing CCR 113 before camera means 122 to permit photographing of any portion of the CCR surface as may be desired. Camera means 122 (not visible in FIG. 2) may employ any desired data acquisition technology, such as but not limited to, visible light photography, infrared and ultraviolet photography, silver halide film, CCD video, and nuclear radiation detection. Images and data acquired by camera means 122 may be analyzed in any fashion desired, which analysis may be facilitated by computer means 124 which may be disposed, for example, in a housing with camera means 122. Many such analytical techniques are well known in the prior art and need not be elaborated upon here.

A presently-preferred method for using first embodiment 100 to monitor particulates on a substrate surface includes any or all of the following steps:

a) moving CCR assembly 112 along first rail 116 to a predetermined axial location adjacent substrate surface 104;

b) engaging CCR 113 in rolling contact with substrate surface 104 to collect particulates therefrom;

c) disengaging CCR 113 from substrate surface 104;

d) moving CCR assembly 112 along first rail 116 to a predetermined axial location adjacent camera means 122;

e) acquiring data from CCR 113 by camera means 122

f) sending acquired data to computer means 124; and

g) engaging CCR 113 with CCR wash unit 118 to regenerate the surface of CCR 113 for reuse.

In a presently preferred embodiment, CCR 113 is relatively short with respect to the width of substrate 102. A short CCR can collect a concentrated contaminant sample by being moved to various axial locations across the substrate. Such a sample can thus represent a widthwise averaging of substrate particulate contamination. A potential drawback of embodiment 100 in some applications is that the particulate information is not obtained in real time, as data acquisition, obtained off-line by camera means 122, inherently occurs at some time period after the relevant portion of the substrate has passed the CCR.

Referring now to FIG. 3, a second embodiment 200 of a substrate contamination monitoring system in accordance with the invention is similar in most respects to first embodiment 100. The CCR assembly and CCR cleaning components may be identical. The important difference in second embodiment 200 is that camera means 222 is mounted on the CCR carrier 230 rather than on second rails 120 and thus travels with CCR 113 and is able to acquire data in real time about particulates removed from the the surface of CCR 113, while the CCR is actively cleaning substrate surface 104.

In use of either embodiment 100 or embodiment 200, it is good practice to bring the rotational speed of CCR 113 up to the linear speed of substrate 102 through use of speed match motor 114 prior to engagement of the substrate by the CCR to prevent scuffing of the substrate surface.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for monitoring particulate contamination of a substrate surface, comprising:
a) a contact cleaning roller for removing at least a portion of said particulate contamination from said substrate surface by adherence to a surface of said contact cleaning roller; and
b) camera means mounted adjacent said contact cleaning roller for acquiring data about said particulate contamination adherent to said contact cleaning roller surface.

2. A system in accordance with claim 1 further comprising means for translating said contact cleaning roller between one or more in-service first positions wherein said contact cleaning roller may be urged into contact with said substrate surface and one or more out-of-service second positions adjacent to an edge of said substrate.

3. A system in accordance with claim 2 wherein said means for translating includes a carrier for said contact cleaning roller, and wherein said camera means is disposed on said carrier for acquiring data from said contact cleaning roller while said contact cleaning roller is in any of said first positions.

4. A system in accordance with claim 2 wherein said camera means is mounted adjacent any of said second positions for acquiring data from said contact cleaning roller while said contact cleaning roller is in any of said second positions.

5. A system in accordance with claim 1 further comprising computer means in communication with said camera means for receiving data signals therefrom, representative of said particulate contamination, which data signals may include images.

6. A system in accordance with claim 1 wherein said data signals may be representative of the shape of said particulates, the areal distribution of said particulates on said substrate surface, and/or the composition of said particulates.

7. A system in accordance with claim 1 wherein said camera means employs data acquisition technology selected from the group consisting of visible light photography, infrared and ultraviolet photography, silver halide film, CCD video, nuclear radiation detection, and combinations thereof.

8. In a system for monitoring particulate contamination of a substrate surface, wherein said system includes a contact cleaning roller for removing at least a portion of said particulate contamination from said substrate surface by adherence to a surface of said contact cleaning roller, and camera means for acquiring data about said particulate contamination adherent to said contact cleaning roller surface,
a method for monitoring particulate contamination of the substrate surface, comprising the steps of:
a) moving said CCR to a location adjacent said substrate surface;
b) engaging said CCR in rolling contact with said substrate surface to collect particulates therefrom; and
c) acquiring data representative of said particulates from said CCR by said camera means.

9. A method in accordance with claim 8 comprising any of the further steps of:
a) disengaging said CCR from said substrate surface;
b) moving said CCR to a predetermined location adjacent said camera means;
c) sending said acquired data to a computer means; and
d) engaging said CCR with a CCR wash unit to regenerate the surface of said CCR for reuse.
